(19) United States
(12) Patent Application Publication
(10) Pub. No.: US 2009/0221351 A1
(43) Pub. Date: Sep. 3, 2009

(54) Gaming Machine

(75) Inventor: Fumio NAKANO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/246,767

(22) Filed: Oct. 7, 2008

Related U.S. Application Data
(60) Provisional application No. 61/032,264, filed on Feb. 28, 2008.

(51) Int. Cl. A63F 9/24; A63F 13/00

(52) U.S. Cl. 463/20

(57) ABSTRACT

A game environment will be described. A change symbol is determined by lottery, if a winning combination including the chance symbol is realized, a free game is shifted. Also, in the free game, a symbol display portion on which the chance symbol is displayed is held and reels are variably displayed on other symbol display portions.

### CROSS-REFERENCE TO RELATED APPLICATIONS

This application is based upon and claims a priority from the U.S. Provisional Patent Application No. 61/032264 filed on Feb. 28, 2008, the entire contents thereof are incorporated herein by reference for all purposes.

### BACKGROUND

1. Field

On or more aspects of invention relate to a gaming machine in which a specific symbol is determined in a first game, and if the specific symbols are stopped with a predetermined number and above, a second game is shifted.

2. Description of Related Art

To enhance entertainment aspects, there are gaming machines in which if specific symbols are stopped with a predetermined number and above, another game is executed. Also, to attract players, a gaming machine which has new feature is anticipated.

### SUMMARY

In view of the foregoing, one or more aspects of the present invention relate to a gaming machine, a gaming method thereof, a computer readable medium having computer-executable instructions or the like in which a new gaming environment. Also, the gaming machine is described in which the specific symbol is determined in the first game, and if the specific symbols are stopped with the predetermined number and above, a game mode is shifted to the second game.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

FIG. 1 is a view showing an example of display content of symbol display portions according to an embodiment of the invention.

FIG. 2 is a view showing an outline of a slot machine according to an embodiment of the invention.

FIG. 3 is a view showing the symbol display portions of the slot machine according to the embodiment of the invention.

FIG. 4 is a block diagram showing an internal configuration of the slot machine according to the embodiment of the invention.

FIG. 5 is a block diagram showing an internal configuration of a sub-control board of the slot machine according to the embodiment of the invention.

FIG. 6 is a view showing symbols displayed on each reel of the slot machine according to one or more aspects of the invention.

FIG. 7 is a view showing symbol rows displayed on each reel of the slot machine according to one or more aspects of the invention.

FIG. 8 is a view showing a condition where reels are variably displayed on variably display portions of the slot machine according to one or more aspects of the invention.

FIG. 9 is a view showing a condition where symbols are stopped displayed on variably display portions of the slot machine according to one or more aspects of the invention.

FIG. 10 is a view showing contents of payout table of the slot machine according to one or more aspects of the invention.

FIG. 11 is a flowchart of a main control process in the slot machine according to one or more aspects of the invention.

FIG. 12 is a flowchart of a main game process in the slot machine according to one or more aspects of the invention.

FIG. 13 is a view showing a table in which each of code numbers corresponds to symbol in the slot machine according to one or more aspects of the invention.

FIG. 14 is a view showing a table in which random number values correspond to code number in the slot machine according to one or more aspects of the invention.

FIG. 15 is a view showing a table in which random number values correspond to symbol in the slot machine according to one or more aspects of the invention.

FIG. 16 is a flowchart of a free game process in the slot machine according to one or more aspects of the invention.

FIG. 17 is a view showing an example of display content of symbol display portions according to an embodiment of the invention.

FIG. 18 is a view showing an example of display content of symbol display portions according to an embodiment of the invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

A gaming machine related to one or more aspects of the invention will be described in detail with reference to drawings based on an embodiment embodying a slot machine.

The slot machine 1 of the embodiment has an image display device such as a liquid crystal display for example, and executes games by displaying images of various symbols on the image display device. That is, the slot machine 1 of the embodiment can be implemented as a video slot machine.

Also, the slot machine 1 of the embodiment can be implemented as a hybrid type slot machine made up of mechanical reels and transparent liquid crystal display device arranged in front of the mechanical reels.

Also, the slot machine 1 of the embodiment can be implemented as a mechanical slot machine having mechanical reels.

Here, in following explanation, slot machines using video reels are mainly described, however, naturally, the present invention is can be applied to slot machines using mechanical reels within applicable limits.

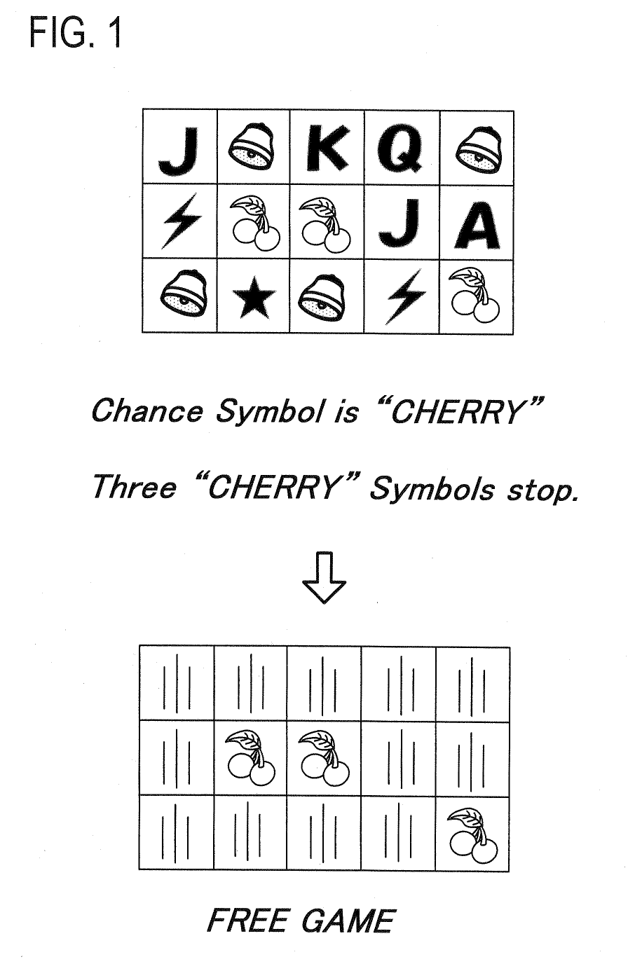

In the slot machine of the embodiment, in a base game, a change symbol is determined by lottery, if a winning combination including the chance symbol (for example, CHERRY symbol) is realized, a free game is shifted. Also, in the free game, symbol display portions on which the chance symbol is displayed is held and reels are variably displayed on other symbol display portions (see FIG. 1).

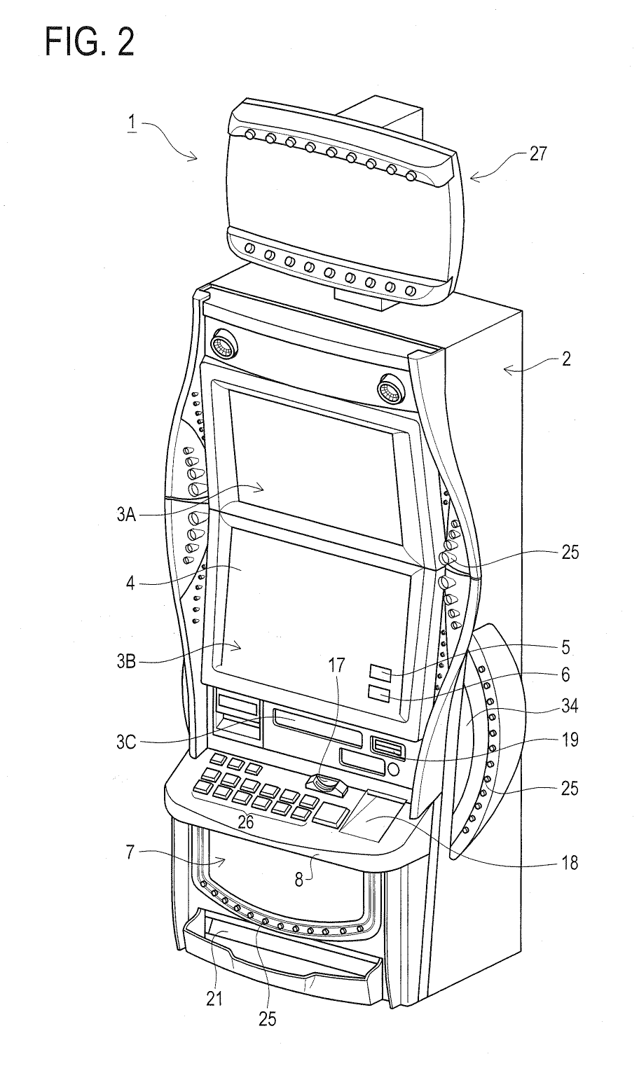

At first, a schematic configuration of a slot machine 1 according to the embodiment will be described with reference to FIG. 2. FIG. 2 is a perspective view showing an outer appearance of the slot machine 1 according to the embodiment.

The slot machine 1 according to the embodiment is an upright-type slot machine positioned in a gaming arcade such as a casino or the like. Here, the outer shape of the slot machine 1 of the embodiment shown in FIG. 2 is given as merely one example, and one or more aspects of the invention is not limited to this outer shape.

The slot machine 1 has a cabinet 2. The cabinet 2 is a housing portion that houses electrical or mechanical components which are used in execution of a predetermined game aspect.

An upper display portion 3A, a main display portion 3B, and an under display portion 3C are arranged in front of the slot machine 1 so as to display different type of game information. The upper display portion 3A is arranged upper side of the cabinet 2, the main display portion 3B is arranged middle side of the cabinet 2, and the under display portion 3C is arranged lower side of the cabinet 2.

The upper display portion 3A is constructed from a liquid crystal panel. Effects images, payout tables of games, game rules, or the like are displayed on the upper display portion 3A.

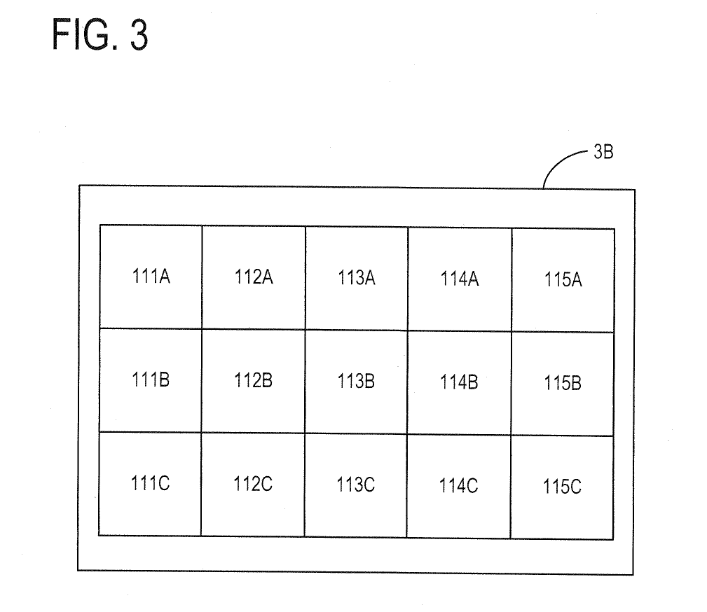

The main display portion 3B is constructed from a liquid crystal panel. For example, as shown in FIG. 3, fifteen of symbol display portions 111A to 115A, 111B to 115B, and 111C to 115C are displayed with 3×5 matrix shape on the main display portion 3B.

On each of the reel display portions, symbol rows are variably displayed. Also, plural symbols are displayed on the reels. When reels are stopped, one symbol will be stopped on the symbol display portion. In the embodiment, each of the symbol display portions corresponds to one reel. That is, in the embodiment, fifteen reels are used. Here, the number of the symbol display portions can be set arbitrarily.

A touch panel 4 is provided at a front face of the main display portion 3B. The player can operate the touch panel 4 to input various types of commands. Also, a payout number display portion 5 and a credit number display portion 6 are arranged on the main display portion 3B. The displayed position of the payout number display portion 5 and the credit number display portion 6 are variable. For example, these are displayed on lower right side portion of the main display portion 3B. Also, a bet number display portion may be arranged so as to display bet number. The payout number which will be provided to the player (that is, payout number to be provided when predetermined symbols are displayed with the predetermined number in a game or a base game and accumulated payout number obtained in free games) are displayed on the payout number display portion 5. The credit number which the player currently owns is displayed on the credit number display portion 6.

The under display portion 3C is constructed form a liquid crystal panel. Number of points stored in a card and/or number of game points are displayed on the under display portion 3C. Also, when the card is not inserted and/or error of reading the card occurs, message which indicates that is displayed.

Also, a card reader 19 is arranged around the under display portion 3C. The card reader 19 can read information from the card in which the player owns.

The upper display portion 3A, the main display portion 3B, and the under display portion 3C are constructed from the liquid display for example, however, one or more aspects of the invention is not so limited. That is, each of the main display portions can be CRT displays, plasma displays, LED displays, or other known display devices.

A lower back panel 7 is arranged lower side of the under display portion 3C and is constructed from plastic panel. Character pictures related to the gaming machine, name of the gaming machine, and the like are displayed and the lower back panel is lit by the backlight. The lower back panel 7 can be CRT displays, plasma displays, LED displays, or other known display devices.

Also, the main display portion 3B can be hybrid type slot machine which is made up of mechanical reels and transparent liquid crystal display device arranged in front of the mechanical reels. In this case, symbols displayed on the mechanical reels are visible perceived via the transparent liquid crystal display device. Also, it is preferable that display windows whose number is the same as the number of the mechanical reels is arranged on the transparent liquid crystal display device and it is constructed so that symbols displayed on the mechanical reels are visible perceived via the window displays. Here, in following explanation, slot machines using video reels are mainly described, however, naturally, the present invention is can be applied to slot machines using mechanical reels within applicable limits. Also, if the mechanical reels are used, the mechanical reels are spin and stopped by motors which are not shown.

An operation table 8 formed by projecting to proximal side is provided at the bottom of the main display portion 3B. Various operation buttons 26, such as an exchange button, a payout button, a help button, a bet button, and start button or the like, are arranged on the operation table 8. An arrangement of these buttons is variable. Also, a part of the buttons can be omitted, and new button can be added or replaced, as needed. Also, a coin insertion slot 17 and a bill verifier 18 are arranged on the operation table 8.

Also, a coin payout opening and a coin receiving portion 21 is formed on lower portion of the cabinet 2. The coin payout opening is a portion where coins are paid out based on inputs of the exchange button or the payout button. And, the coin receiving portion 21 is a portion where the coins which are paid out from the coin payout opening are received. A coin detection portion made up of sensor or the like is arranged inside the coin payout opening. The coin detection portion detects the number of coins which are paid out from the payout opening.

Light emitting portions 25, which lights up in a predetermined lighting pattern when winning combination is realized and during the free game, are arranged around the cabinet 2 of the slot machine 1. Loudspeakers 34 which outputs audio are arranged at side of the cabinet 2. Here, arranged positions of the light emitting portion 25 and the loudspeaker 34 are variable.

The slot machine 1 has a topper effect device 27 provided at an upper side of the cabinet 2. This topper effect device 27 has a rectangular board shape and is arranged so as to be substantially parallel with the upper display portion 3A. Here, the shape of the topper effect device 27 is variable. Different types of information are displayed on the topper effect device 27.

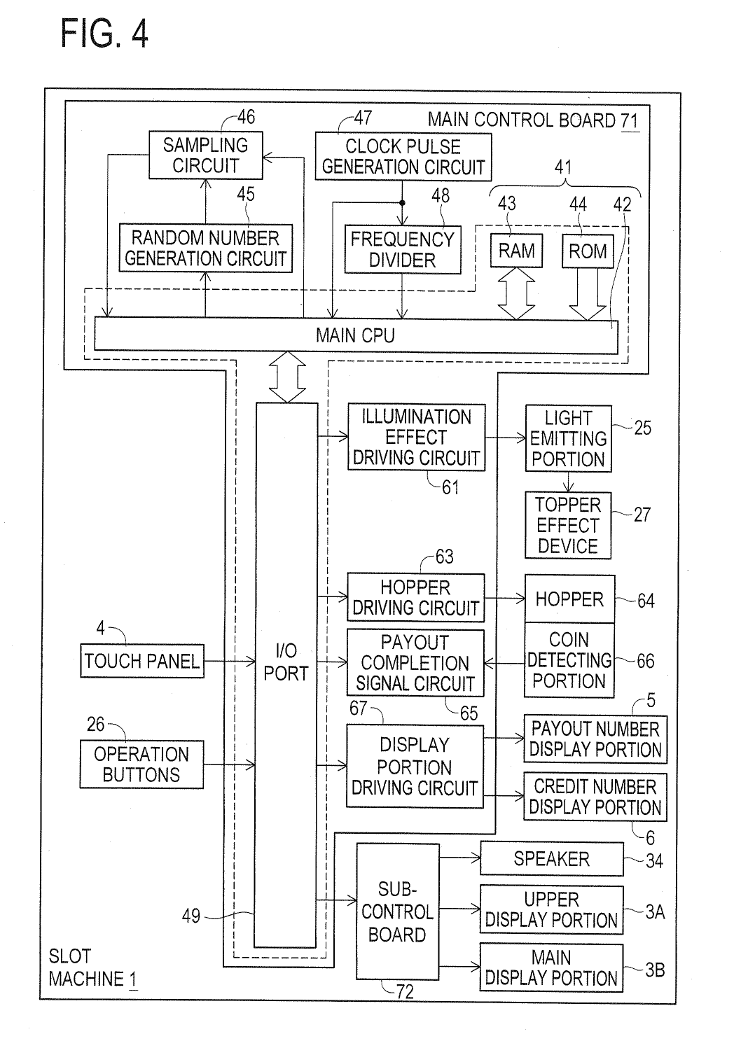

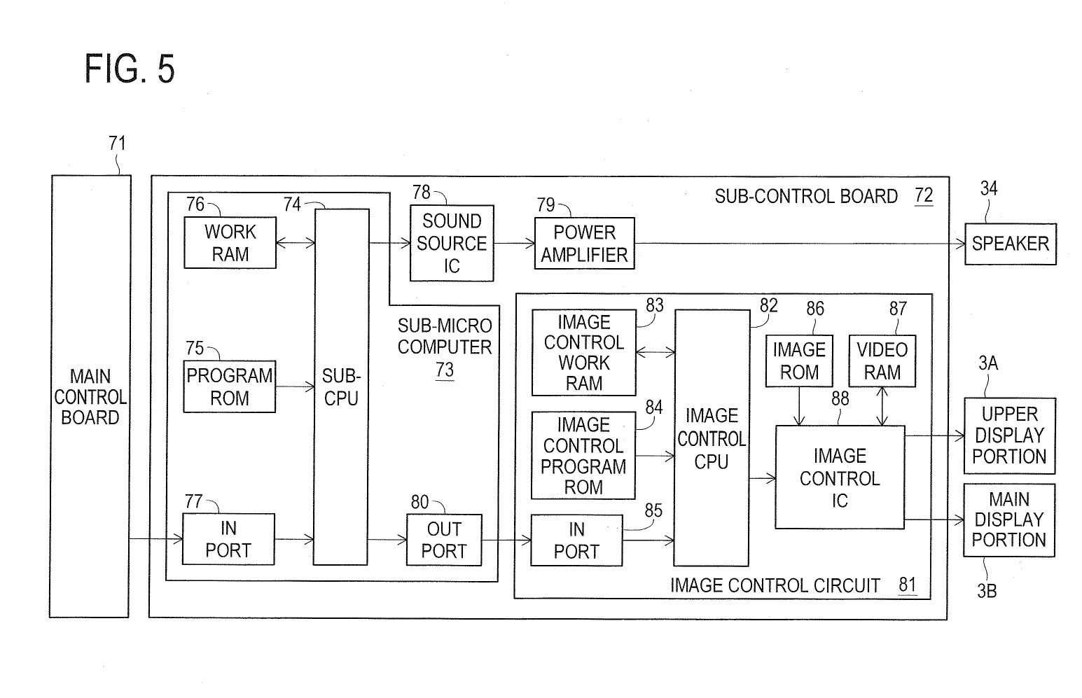

Next, the internal configuration of the above-mentioned slot machine 1 will be described with reference to FIG. 4 and FIG. 5. FIG. 4 is a block diagram showing an internal configuration of the entire slot machine 1. As shown in FIG. 4, the slot machine 1 has a plurality of constituent elements arranged around a main control board 71 including a controller 41 that executes control programs that will be described later. The main control board 71 has a controller 41, a random number generation circuit 45, a sampling circuit 46, a clock pulse generation circuit 47, a divider 48, an illumination effect driving circuit 61, a hopper driving circuit 63, a payout completion signal circuit 65 and a display portion driving circuit 67.

The controller 41 has a main CPU 42, a RAM 43 and a ROM 44. The main CPU 42 operates in accordance with the programs stored in the ROM 44 and performs signal input and output with respect to the other constituent elements through an I/O port 49. Specifically, the main CPU 42 controls the operation of the entire slot machine 1. The RAM 43 stores data and programs to be used when the main CPU 42 is operating. For instance, the RAM 43 temporarily retains the random number values which have been sampled by the sampling circuit 46 after the game has started. The RAM 43 stores code numbers which will be described later.

The ROM 44 programs that will be executed by the main CPU 42, as well as permanent data.

More particularly, the programs stored in the ROM 44 include game programs and game system programs (hereinafter referred to as game programs or the like). Further, the game programs include lottery programs as will be described later.

Also, in a case where the slot machine of the embodiment is implemented as the video machine, symbol images constructing the video reel are stored in the ROM 44.

The lottery programs are used to determine the code numbers corresponding to symbols to be displayed on center positions of each symbol display portion of the main display portion 3B. A correspondence relationship between code numbers and symbols will be described later.

The random number generation circuit 45 operates in accordance with the commands from the main CPU 42 and generates random numbers within a predetermined range. The sampling circuit 46 selects, by lottery, an arbitrary random number from the random numbers generated by the random number generation circuit 45 in response to a command from the main CPU 42. At the same time, the sampling circuit 46 inputs the random number thus selected to the main CPU 42. The clock pulse generation circuit 47 generates a reference clock for causing the main CPU 42 to operate. The divider 48 inputs a signal obtained by dividing the reference clock by a constant frequency to the main CPU 42.

The main control board 71 is connected to the touch panel 4. As described above, the touch panel 4 is arranged at a front face of the main display portion 3B and is adapted to identify a coordinate position of the portion that was touched by the player. Specifically, the touch panel 4 can discriminate the portion that the player has touched, and in what direction the touched portion was moved based on the coordinate position information that was thus identified. A signal in accordance with the above discrimination is then inputted to the main CPU 42 through the I/O port 49.

The main control board 71 is connected to the operation button 26 (the start button and the like, as mentioned above) and a signal in accordance with a depression operation of these buttons is inputted to the main CPU 42 through the I/O port 49.

The illumination effect driving circuit 61 outputs an effect signal for causing the light emitting portions 25 and the topper effect device 27 as mentioned above to perform illumination effects. The topper effect device 27 is connected in series with the illumination effect driving circuit 61 through the light emitting portions 25.

The hopper driving circuit 63 drives the hopper 64 under the control of the main CPU 42. As a result, the hopper 64 carries out an operation to payout coins to the coin payout opening. The payout completion signal circuit 65 receives coin amount value data from the coin detecting portion 66 to which it is connected. Then, when the received coin amount value has reached the set coin amount value, the payout completion signal circuit 65 inputs a signal that notifies completion of coin payout to the main CPU 42. The coin detecting portion 24 detects the number of coins that were paid out by the hopper 64 and then inputs coin amount value data showing the amount of coins that was detected to the payout completion signal circuit 65. The display portion driving circuit 67 controls the display operation of the respective display portions including the payout number display portion 5, the credit number display portion 6, and the like.

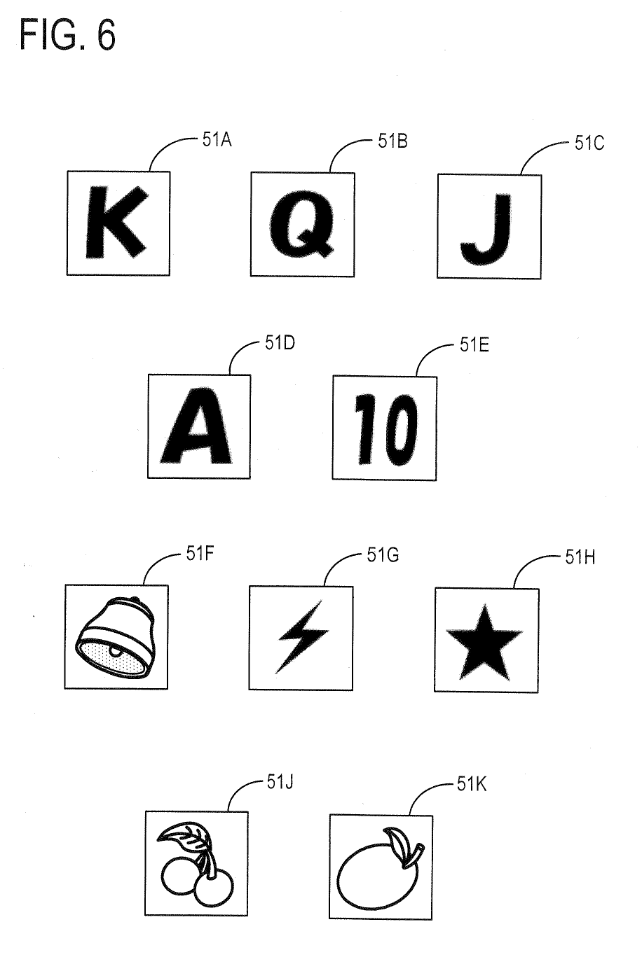

The main control board 71 is connected to the sub-control board 72. As shown in FIG. 6, the sub-control board 72 carries out display control of each of the display portion and output control of the audio outputted by the loudspeaker 34, based on the commands received from the main control board 71. This sub-control board 72 is constituted on a separate circuit board from the circuit board that constitutes the main control board 71. The sub-control board 72 has a micro computer (hereinafter referred to as “sub-micro computer”) 73 which is provided as a main constituting element. Then, the sub-control board 72 has a sound source IC 78, a power amplifier 79, and an image control circuit 81. The sound source IC 78 controls the audio output from the loudspeaker 34. The power amplifier 79 functions as an amplifier. The image control circuit 81 operates as a display control section for the upper display portion 3A and the main display portion 3B.

The sub-micro computer 73 has a sub-CPU 74, a program ROM 75, a work RAM 76 and I/O ports 77 and 80. The sub-CPU 74 carries out a control operation in accordance with a control command transmitted from the main control board 71. Although the sub-control board 72 does not have a clock pulse generation circuit, a divider, a random number generation circuit and a sampling circuit, it is constituted so as to execute sampling of random numbers based on an operation program of the sub-CPU 74. The program ROM 75 stores a control program to be executed by the sub-CPU 74. The work RAM 76 is constituted as a temporary memory to be used by the sub CPU 74 in executing the control program.

The image control circuit 81 has an image control CPU 82, an image control work RAM 83, an image control program ROM 84, an image ROM 86, a video RAM 87 and an image control IC 88. The image control CPU 82 determines the image to be displayed on the upper display portion 3A and the main display portion 3B based on the parameters set in the sub-micro computer 73 and the image control programs stored in the image control program ROM 84. For example, the upper display portion 3A displays a payout table and a help screen. The main display portion 3B carries out scrolled display and stopped display on the respective symbol display portions 111A to 111C, 112A to 112C, 113A to 113C, 114A to 114C, and 115A to 115C.

The image control program ROM 84 stores an image control program and various types of selection tables relating to display on the upper display portion 3A and the main display portion 3B. The image control work RAM 83 functions as a temporary memory to be used in execution of the image control program in the image control CPU 82. The image control IC 88 forms an image in accordance with the contents determined by the image control CPU 82 and then outputs the image thus formed to the upper display portion 3A and the main display portion 3B.

The image ROM 86 stores dot data for forming an image. The video RAM 87 functions as a temporary memory to be used by the image control IC 88 in forming an image.

Here, the internal construction of the slot machine 1 as mentioned above is merely one example and one or more aspects of the invention is not so limited. For example, memory card and/or PLD (Programmable Logic Device) may be detachably from the slot machine 1 and necessary information may be read from the memory card and/or the PLD.

The slot machine 1 of the embodiment employs coins, bills or electronic value information (credit) corresponding to these, as gaming values. The gaming values applicable to the present invention are not limited to those described above, and can include, for instance, medals, tokens, electronic money and tickets. In the embodiment, it is mainly described that credit(s) are provided, however, one or more aspects of the invention is not so limited to the embodiment.

Next, the symbols displayed on reel variably displaying on the symbol display portion will be described with reference to FIG. 6. FIG. 6 shows on example of kinds of symbols displayed on the reel variably displaying on the symbol display portion.

The symbols used in the embodiment include KING symbol 51A, QUEEN symbol 51B, JACK symbol 51C, ACE symbol 51D, TEN symbol 51E, BELL symbol 51F, THUNDER symbol 51G, STAR symbol 51H, CHERRY symbol 51J, PLUM symbol 51K.

The number of the symbols which are displayed on one reel is variable and the type of the displayed symbols is variable.

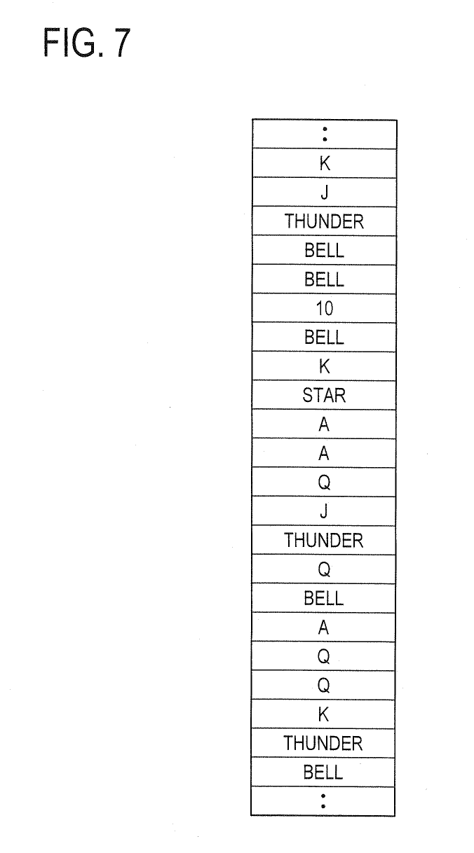

FIG. 7 is a view showing one example of reel to be variably displayed on each of the symbol display portions.

Here, a sequence of the symbols shown in FIG. 7 is merely one example, and the sequence of the symbols can be set arbitrarily.

Also, reels to be used can be different on each symbol display portion. Also, plural reels are equipped and the reel can be selected based on payout ratio which is set.

Next, games executed in the slot machine 1 of the embodiment will be described. The games executed in the embodiment are constructed from two of games. The two of games is the base game and the bonus game. The free game will be described later.

The base game will be described. In the base game, a winning combination is determined based on the number of same symbols displayed on the symbols display portions 111A to 111C, 112A to 112C, 113A to 113C, 114A to 114C, and 11SA to 115C on the main display portion 3B, and an award corresponding to the winning combination is provided.

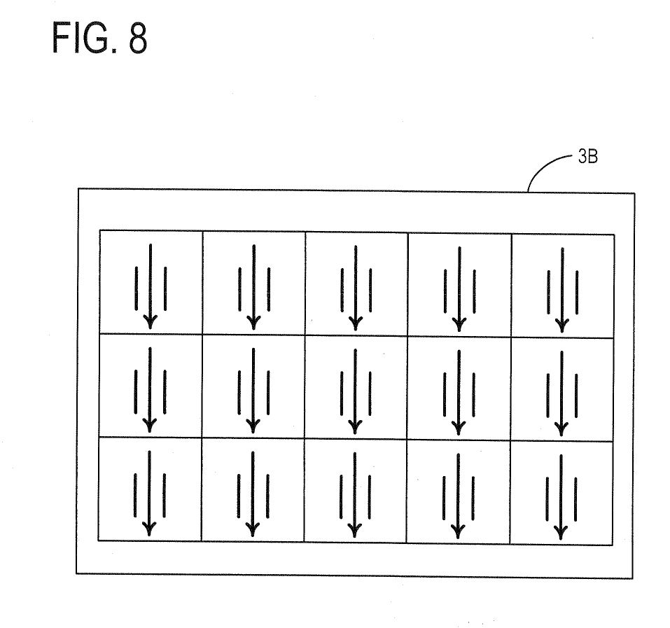

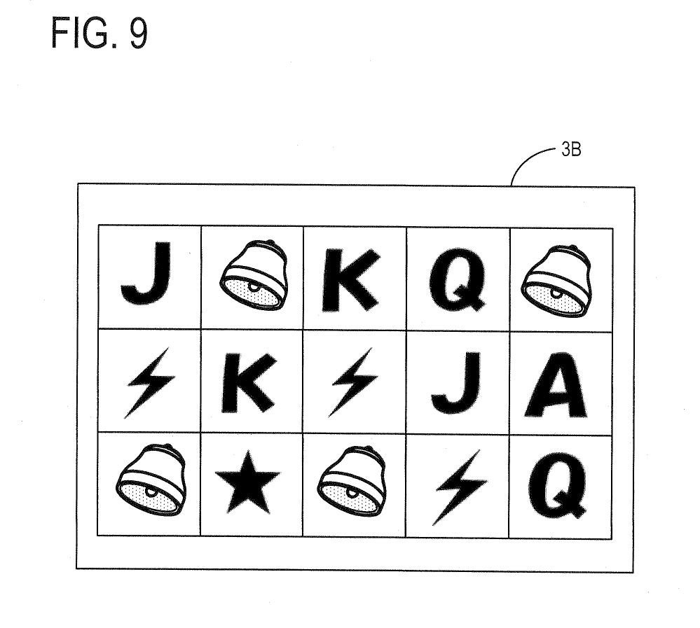

When the bet count is determined based on the operation of the bet button, and then the start button is input, the reels start to spin on the each of the reel display portions. Accordingly, the symbol rows displayed on the reel are scrolled from top to bottom, as shown in FIG. 8. After a predetermined time, the reels are stopped displayed on the reel display portions. Accordingly, one symbol on each reel is displayed in the symbol display portion of the main display portion 3B, as shown in FIG. 9. Here, scroll direction can be from the bottom to top not limited to from top to bottom. Also, the scroll direction can be different on each reel display portion. Also, the scroll direction can be different on each game.

In the embodiment, stopping sequence of the symbol display portions can be set arbitrarily. That is, reels can be stopped on all of the symbol display portions (symbol display portions 111A to 115A, 111B to 115B, and 111C to 115C) at once.

After, reels are stopped, the winning combination is determined based on the number of the same displayed symbols and an award corresponding to the determined winning combination will be provided. If the winning combination is realized, amount of outcome, which the payout number corresponding to the winning combination is multiplied by the bet number, is provided to the player.

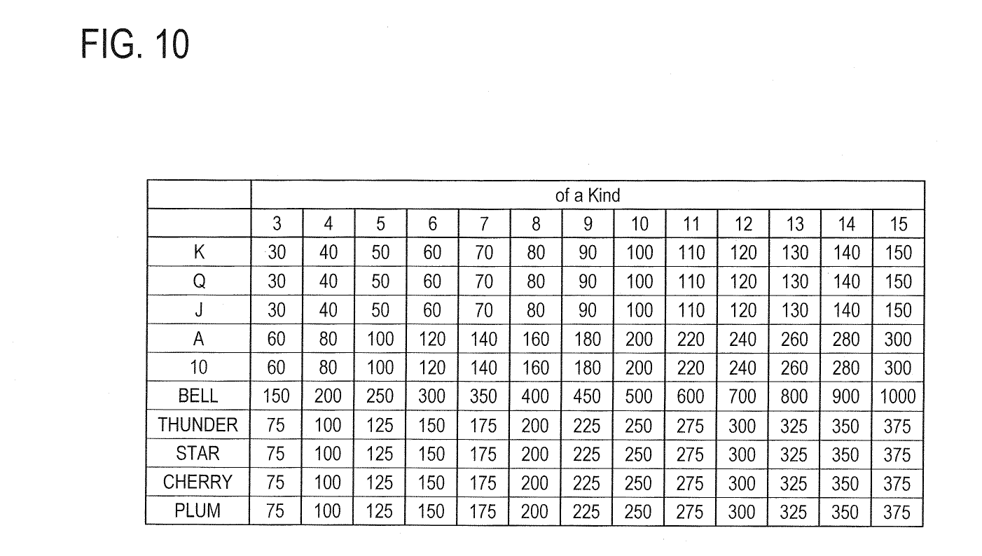

The winning combination and payout number thereof used in the game in the slot machine 1 of the embodiment will be described with reference to FIG. 10. FIG. 10 shows payout table which indicates the winning combination and payout number thereof used in the game.

FIG. 10 indicates the payout number in the case where the bet count is “1”. If the bet count is “1”, the payout number shown in FIG. 10 will be provided. If the bet count is more than “2”, the payout number shown in FIG. 10 will be multiplied by the bet count, and multiplied number will be provided.

For example, if five of KING symbols 51A are displayed on five symbol display portions from the symbol display portions 111A to 115A, 111B to 115B, 111C to 115C, amount of outcome which 50 credit is multiplied by the bet number will be provided to the player.

For example, if four of ACE symbols 51B are displayed on five symbol display portions from the symbol display portions 111A to 115A, 111B to 115B, 111C to 115C, amount of outcome which 80 credit is multiplied by the bet number will be provided to the player.

In a similar way, the payout numbers are defined on each of the winning combinations shown in FIG. 10. Here, the displayed symbols on the symbol display portions 111A to 115A, 111B to 115B, 111C to 115C are not associated with any of the winning combinations shown in FIG. 10, the game is lost. If the game is lost, none of the payout number will be paid.

Here, the payout table shown in FIG. 10 is merely one example, and the types of the winning combinations and the payout number is variable. Also, in one or more aspects of the invention, plural payout tables are provided and the payout table can be selected based on the payout ratio which is set. Also, payout table used in the free game can be different from the payout table used in the base game.

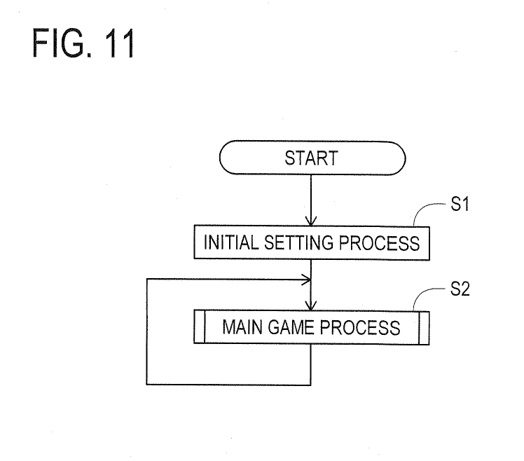

Next, a main control program executed in the slot machine 1 of the embodiment will be described in detail with reference to drawings. FIG. 11 is a flowchart of the main control program.

First, when the power switch is turned on (upon power on), the main control board 71 and the sub-control board 72 are activated, and the controller 41 executes an initial setting process at step (hereinafter referred to as S) 1. In the initial setting process, the main CPU 42 executes the BIOS stored in the ROM 44 and expands the compressed data incorporated in the BIOS in the RAM 43. By executing the BIOS that was expanded in the RAM 43, the main CPU 42 carries out a diagnosis and initialization of the different types of peripheral devices. Further, the main CPU 42 writes the game programs and the like from the ROM 44 into the RAM 43 to acquire payout rate setting data and country identification information. While executing the initial setting process, the main CPU 42 also carries out an authentication process with respect to each program.

Then, at step S2, the main CPU 42 sequentially reads the game programs and the like from the RAM 43 and executes these programs to carry out a main game process. The slot machine 1 according to the embodiment carries out the game by executing this main game process. The main game process is repeatedly executed while power is supplied to the slot machine 1.

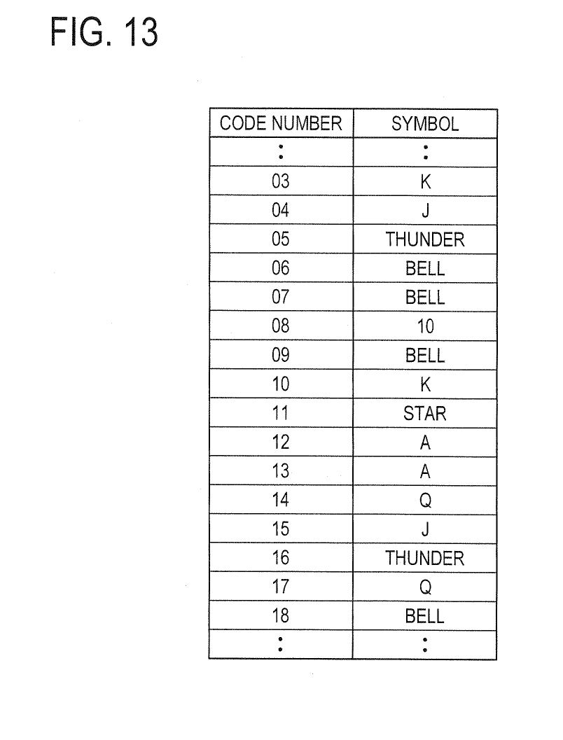

Next, a sub-process of the main game process at the above-described step S2 will be described based on FIG. 13. FIG. 13 is a flowchart of the main game process program to be executed in the slot machine 1 according to the embodiment. The programs of the flowcharts as will be described later are stored in the ROM 44 and RAM 43 provided in the slot machine 1 and are executed in the main CPU 42.

At S11, the start acceptance process is executed. In the start acceptance process, the player inserts coins and places a bet using the BET button from amongst the operation buttons 26.

At S12, the main CPU 42 determines whether or not the start button from amongst the operation buttons 26 has been depressed. That is, it is determined whether or not the start button is ON. This determination is carried out based on the signal inputted to the main CPU 42 in response to depression of the start button. Here, if the start button has not been depressed (S12: NO), the flow returns to the start acceptance process (S11). As a result, the player can carry out an operation to correct, etc. the bet amount. Alternatively, if the start button has been depressed (S12: YES), the main CPU 42 subtracts the bet amount set based on the above-described bet operation from the credit amount that the player currently possesses and at the same time stores the result as bet information in the RAM 43. After that, the procedure will be shifted to S13.

At S13, the symbol lottery process is executed. Concretely, the main CPU 42 samples random number value from a number value range within a predetermined random number value range by executing the lottery program stored in the RAM 43, and determines symbols to be stopped on each symbol display portion based on the sampled random number values and the table.

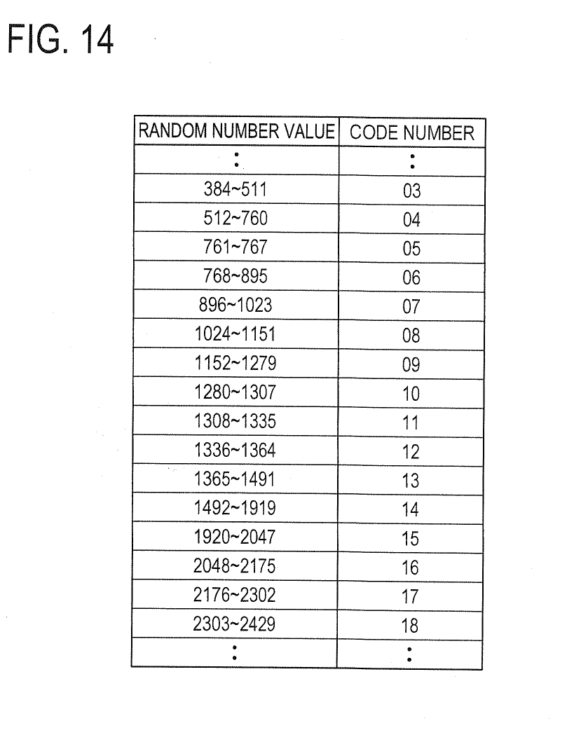

Here, a process using random number values at S13 will be described. FIG. 13 shows one example of a table in which symbols displayed on reels shown in FIG. 7 correspond to code numbers. FIG. 14 is one example of a table in which random number values correspond to the code numbers. The code numbers are determined with the use of the table shown in FIG. 14 based on the sampled random number values among predetermined random number range (for example, from 0 to 65535). The symbols to be stopped are determined with the use of the determined code numbers and the table shown in FIG. 13.

Here, as shown in FIG. 14, since the number of random number values corresponding to each code number is different, each of probabilities of appearance of each symbol shown in FIG. 14 is controlled. For example, in FIG. 14, code number “4” corresponds to random number values “512” to “760”, code number “5” corresponds to “761” to “767”. Therefore, since the code number “4” may more appear than the code number “5”, the JACK symbol 51C corresponding to the code number “4” may more appear than the THUNDER symbol 51G corresponding to the code number “5”.

For example, with respect to the symbol display portion 113A, in a case where reel shown in FIG. 7 is used and “1136” is sampled, it is determined that code number is “08” based on the table shown in FIG. 14. And then, it is determined that the TEN symbol 51E corresponding to the code number “08” will be displayed on the symbol display portion 113A with the use of the table shown in FIG. 13.

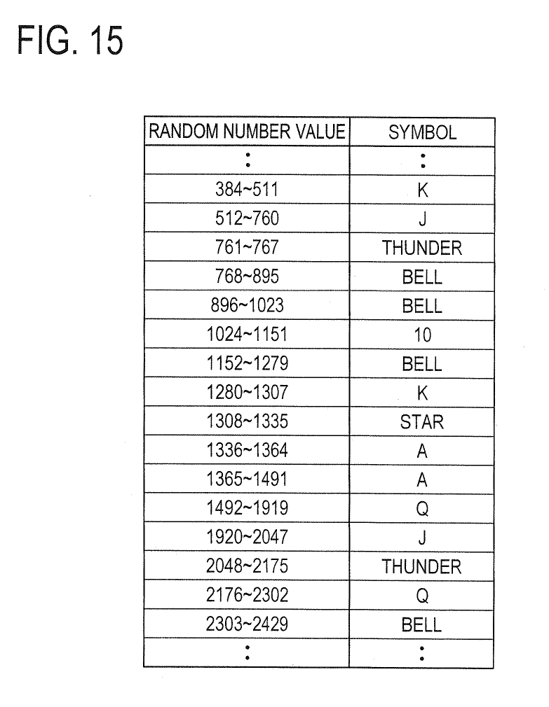

Also, as shown in FIG. 15, the random number values to be sampled may correspond to symbols.

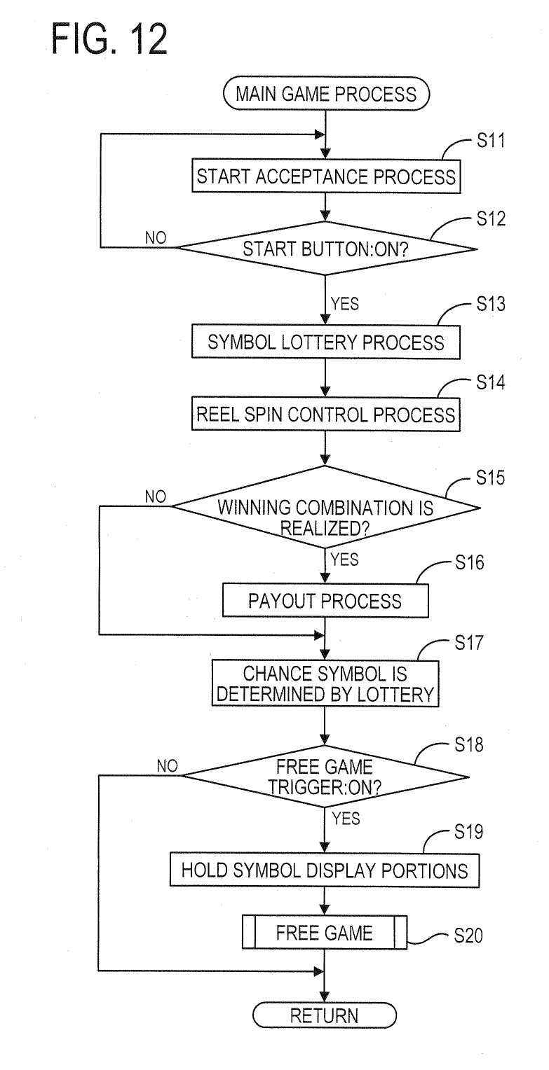

Returning to FIG. 12, at S14, a reel spin control process is executed. Specifically, the main CPU 42 variably displays each of the reels on the symbol display portions 111A to 115A, 111B to 115B, and 111C to 115C. After that, the main CPU 42 determines effects pattern (image display pattern of the main display portion 3B, sound output pattern of the loudspeaker 34, or the like) in a unit game and send predetermined signal to sub-control board 72 so as to start effects based on the determined effects pattern. Here, the unit game means a sequence of process where each of the reels starts to variably display and then the entire reels are stopped displayed.

Then, after the lapse of a predetermined period of time, reels are stopped to spin on the symbol display portion 111A to 115A, 111B to 115B, and 111C to 115C. Accordingly, symbols are stopped on each of the symbol display portions 111A to 111C, 112A to 112C, 113A to 113C, 114A to 114C, and 115A to 115C.

After that, at S15, the main CPU 42 determines whether or not the symbols arranged on the main display portion 3B are the winning combination. That is, it is determined whether or not the winning combination is realized. This determination is performed based on the code numbers of each symbol display portion 111A to 111C, 111B to 115B, and 111C to 115C stored in the RAM 43.

At a result, if it is determined that the winning combination is realized (S15:YES), the procedure will be shifted to S16. On the other hand, if it is determined that none of the winning combinations is not realized (S15:NO), the procedure will be shifted to S17.

At S16, the main CPU 42 provides the payout number corresponding to the winning combination which is determined at S15 to the player. That is, the payout process is executed. After that, the procedure will be shifted to S17.

At S17, the chance symbol is determined by lottery. One chance symbol is selected among symbols shown in FIG. 6. In this time, each of probabilities of each symbol to be selected can be the same or can be different.

At S18, it is determined whether or not the free game trigger is ON. In the embodiment, if a winning combination including the symbol selected at S17 (the chance symbol) is realized, the free game trigger becomes ON. Also, if the chance symbol is stopped, the trigger can become ON even though the winning combination is not realized.

If it is determined “YES” in S18, the procedure will be shifted to S19. On the other hand, if it is determined “NO” in S18, the main game process will be terminated.

At S19, the symbol display portion on which the chance symbol is displayed is held.

At S20, the free game is executed.

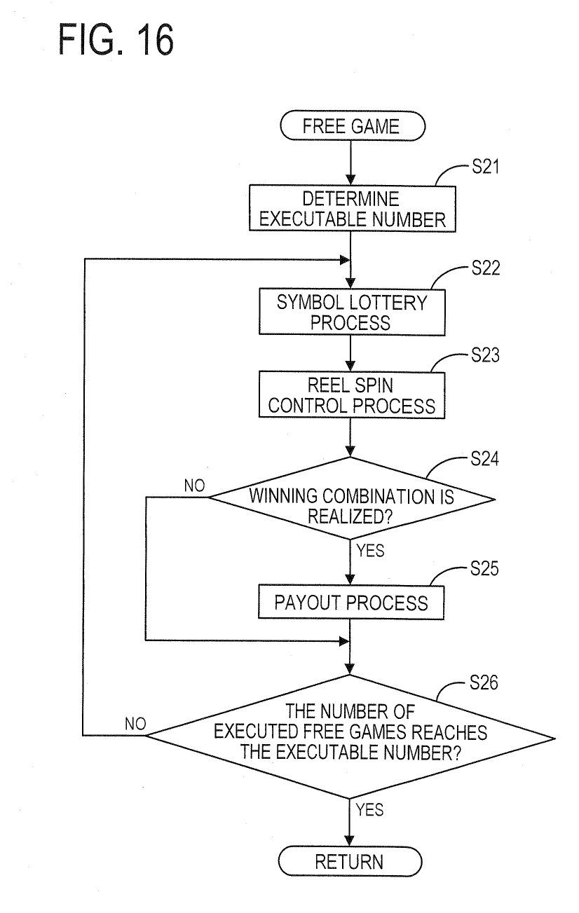

The free game will be described. FIG. 16 is a flowchart of the free game process.

At S21, the number of executable free games is determined. The number of executable free games can be determined based on the number of the chance symbols which were displayed in latest base game. Also, as the number of displayed chance symbols is larger, the number of executable free games is larger.

Also, the number of executable free games can be determined by lottery. Also, the process of S21 can be skipped. That is, the number of executable free games can be constant value.

Since the processes of S22 through S25 are the same as the processes of S13 through S16 as above, explanations thereof will be omitted.

At S26, it is determined whether or not the number of executed free games reaches the number of executable free games.

If it is determined that the number of executed free games does not reach the number of executable free games (S26:NO), the procedure will be shifted to S22.

On the other hand, if it is determined that the number of executed free games reaches the number of executable free games (S26:YES), the procedure will be terminated.

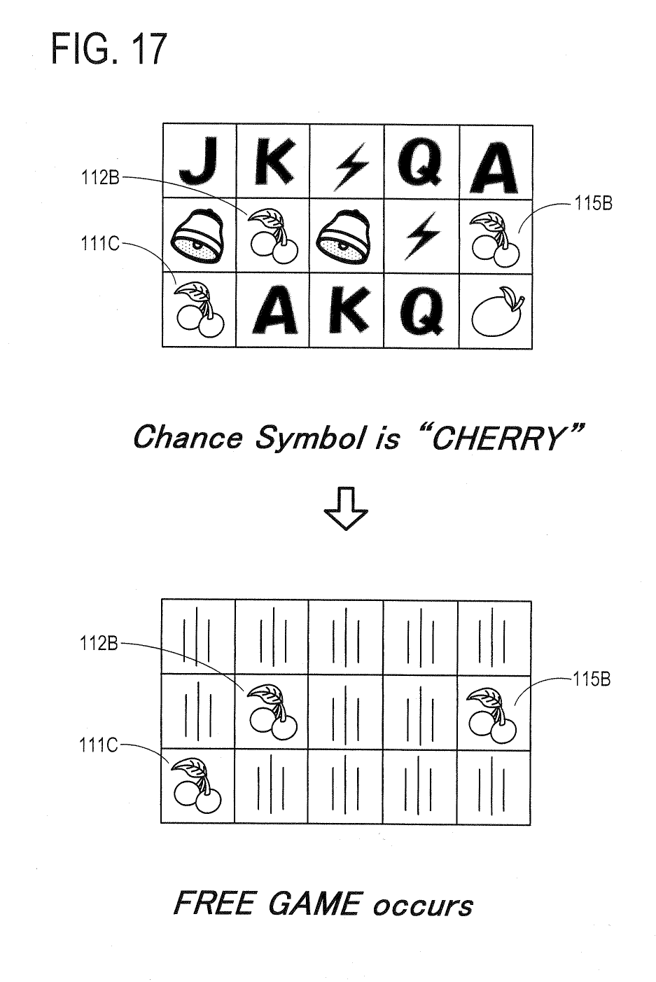

FIG. 17 shows one example of display content of the symbol display portions. In FIG. 17, the CHERRY symbol 51J is the chance symbol.

As shown in FIG. 17, three of the CHERRY symbols 51J are displayed on the symbol display portions. That is, the winning combination “3 of a kind of CHERRY SYMBOLs” is realized (see FIG. 10).

Accordingly, as shown in FIG. 17, the free game will be executed with a condition where symbol display portions 112B, 115B, and 111C are held.

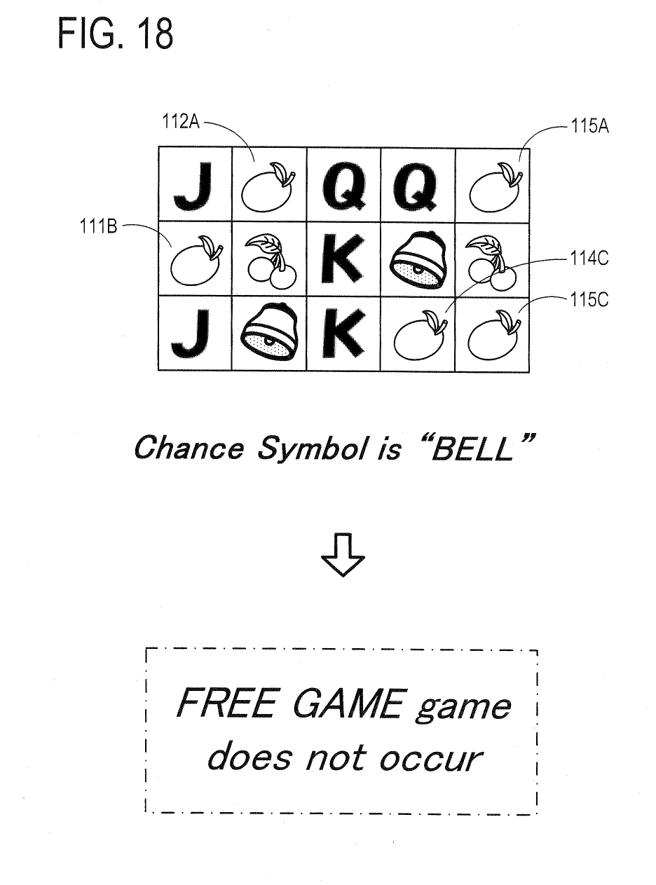

FIG. 18 shows one example of display content of the symbol display portions. In FIG. 18, the BELL symbol 51F is the chance symbol.

As shown in FIG. 18, five of the PLUM symbols 51K are displayed on the symbol display portions. That is, the winning combination “5 of a kind of PLUM SYMBOLs” is realized (see FIG. 10).

However, since the PLUM symbol 51K is not the chance symbol, the free game will not be executed (see FIG. 18).

As mentioned above, in one or more aspects of the invention, in the in a base game, a change symbol is determined by lottery, if a winning combination including the chance symbol is realized, a free game is shifted. Also, in the free game, symbol display portions on which the chance symbols are displayed are hold, and reels are variably displayed on other symbol display portions.

Accordingly, newly gaming machine can be provided, and the entertainment will be enhanced.

The present invention is not limited to above embodiments and various changes and modifications can be done within the scope of the present invention certainly.

For example, the free game as above can be implemented as additional game of the base game.

Also, one or more aspects of the invention can be implemented as a slot machine using paylines. In this case, if a combination of symbols stopped on the payline is any of winning combinations, an award corresponding to the winning combination will be provided. Also, the number of the paylines is variable, for example, it can be eight lines. Also, the number of symbol display portions can be nine.

Also, the present invention can be implemented as a playing method to execute above processes. Further, the present invention can be implemented as a program to execute above processes in one or more computers, and a tangible medium in which the program is stored.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display that displays plural symbol display portions, each of the symbol display portions displaying a symbol; and
a processor that controls display content of the display and a session of a game, the game including a first game and a second game;
wherein the processor is programmed to:
(a) accept a start indication of the first game,
(b) variably display the symbols on the symbol display portions when the start indication is accepted,
(c) stop the symbols on the symbol display portions,
(d) provide an award corresponding a winning combination if a combination of the displayed symbols is the winning combination,
(e) determine a specific symbol by lottery,
(f) count a number of the displayed specific symbols, and
(g) execute the second game if the counted number of the displayed specific symbols is a predetermined number and above.

2. The gaming machine according to claim 1, wherein the specific symbol is determined every the first game.

3. A gaming machine comprising:
a display that displays plural symbol display portions, each of the symbol display portions displaying a symbol; and
a processor that controls display content of the display and a session of a game, the game including a first game and a second game;
wherein the processor is programmed to:
(a) accept a start indication of the first game,
(b) variably display the symbols on the symbol display portions when the start indication is accepted,
(c) stop the symbols on the symbol display portions,
(d) provide an award corresponding a winning combination if a combination of the displayed symbols is the winning combination,
(e) determine a specific symbol by lottery,
(f) count a number of the displayed specific symbols,
(g) execute the second game if the counted number of the displayed specific symbols is a predetermined number and above, and
(h) hold the specific symbol during the second game.

4. The gaming machine according to claim 3, wherein the specific symbol is determined every the first game.

5. A gaming machine comprising:
a display that displays plural symbol display portions, each of the symbol display portions displaying a symbol; and
a processor that controls display content of the display and a session of a game, the game including a first game and a second game;
wherein the processor is programmed to:
(a) accept a start indication of the first game,
(b) variably display the symbols on the symbol display portions when the start indication is accepted,
(c) stop the symbols on the symbol display portions,
(d) provide an award corresponding a winning combination if a combination of the displayed symbols is the winning combination,
(e) determine a specific symbol by lottery,
(f) count a number of the displayed specific symbols,
(g) determines a number of executable second games, and
(h) execute the second game with the determined number of times.

6. The gaming machine according to claim 5, wherein the number of executable second games is determined based on the number of the displayed specific symbols on the display.
